(19) United States
(12) Patent Application Publication
(10) Pub. No.: US 2024/0345045 A1
(43) Pub. Date: Oct. 17, 2024

(54) ABSOLUTE QUANTITATION OF NITROSAMINES

(71) Applicant: New Jersey Institute of Technology, Newark, NJ (US)

(72) Inventors: Hao Chen, Livingston, NJ (US); Qi Wang, Kearny, NJ (US)

(73) Assignee: New Jersey Institute of Technology, Newark, NJ (US)

(21) Appl. No.: 18/633,136

(22) Filed: Apr. 11, 2024

Related U.S. Application Data
(60) Provisional application No. 63/458,749, filed on Apr. 12, 2023.

(51) Int. Cl. G01N 30/72; B01D 15/08; G01N 27/27; G01N 30/02; G01N 30/64

(52) U.S. Cl. CPC G01N 30/7266; B01D 15/08; G01N 27/27; G01N 30/64; G01N 2030/027

(57) ABSTRACT

A method for absolute quantification of nitrosamines without using standards is disclosed. The method involves reducing nitrosamines to hydrazines and coulometric mass spectrometric (CMS) quantitation is then applied to quantify the hydrazines, thus quantifying their precursor nitrosamines, as the reduction yields can be measured by mass spectrometry (MS).

### CROSS-REFERENCE TO RELATED APPLICATIONS

This application claims priority to U.S. Provisional Application No. 63/458,749, filed Apr. 12, 2023, the entire disclosure of which is hereby incorporated by reference herein.

### FIELD OF THE DISCLOSURE

The present disclosure relates to quantification. In particular, the present disclosure relates to absolute quantification of nitrosamines without using any standards.

### BACKGROUND

N-nitrosamines (R₂N—N═O) are compounds containing a nitroso group bonded to an amine. The nitrosating reaction between secondary, tertiary, or quaternary amines and nitrous acid at elevated temperature is deemed as the primary source for nitrosamine generation. Most nitrosamines are classified as Group 2A or Group 2B by the U.S. Environmental Protection Agency and possibly carcinogenic to humans.¹ Nitrosamines are frequently detected during food processing and water treatment. Recently, nitrosamine impurities have unexpectedly been found in drugs such as angiotensin II receptor blockers, ranitidine, nizatidine, and metformin2 at unacceptable levels, leading to several batches recalls. Drug product recalls not only result in expensive cost but also more importantly cause medicine shortage crisis for tens of millions of patients.

Common nitrosamine impurities detected in drugs include N-nitrosodimethylamine (NDMA), N-nitroso-diethylamine (NDEA), N-ethyl-N-nitroso-2-propanamine (NEIPA), N-nitroso-diisopropylamine (NDIPA), N-nitroso-di-N-propylamine (NDPA), N-nitroso-methylphenylamine (NMPA), N-nitroso-di-N-butylamine (NDBA), and N-nitroso-methyl-4-aminobutyric acid (NMBA). However, as long as drug parent molecules have a secondary, tertiary, or quaternary amine, it could form nitrosamines during storage and this kind of parent drug nitrosamines lack standards. The FDA recommends that manufacturers take appropriate measures to control nitrosamine impurities to acceptable levels; for example, the acceptable intake (Al) limit of NDMA and NMBA is 96 ng/day, the acceptable intake limit for NDEA, NMPA, NIPEA, and NDIPA should not be more than 26.5 ng/day.¹ Therefore, identification and quantitation of drug nitrosamine impurities are urgent for the pharmaceutical industry.

Absolute quantitation refers to determining the actual quantity of an analyte in a sample, such as concentration or mass of the analyte in the sample. Generally, chromatographic methods such as gas chromatography (GC)³ and liquid chromatography (LC)⁴⁻⁵ are two main reported approaches for N-nitrosamines quantitation, but standards have to be used for quantitation. However, the major challenge in nitrosamine quantitation is that, as newly discovered compounds, drug nitrosamine impurities, particularly these active pharmaceutical ingredient (API)-related nitrosamines, lack standards. Typically, de novo synthesis of standards would not only be synthetically challenging but also cost a significant amount of money and time (e.g., synthesis of 1 g of API-related nitrosamine VII costs over $15,000 and 1 month time). Although some methods such as electrochemistry-based sensor⁶⁻⁷ and UV-photolysis coupled with chemiluminescence detection⁸ have been developed for nitrosamine quanatitation, those methods were generally less selective and normally used to measure the total amount of nitrosamines in a sample.

Accordingly, there is a need in the art for methods for quantifying nitrosamines without the need of using standards.

### SUMMARY

To eliminate the need for using standards or calibration curves for drug nitrosamine impurity quantitation, the inventors use coulometric mass spectrometry (CMS),³⁻⁷ a technique that was recently developed in the inventors' laboratory for direct absolute quantitation of peptides and proteins but has not been used for quantifying nitrosamines.

In accordance with embodiments of the present disclosure, methods and systems for absolute quantification of nitrosamines without using standards are disclosed. In one embodiment, the methods and systems could apply to N-nitrosamines and their derivatives with high sensitivity and specificity. In one embodiment, a method is disclosed using a coulometric mass spectrometric (CMS) approach to quantify and identify trace amounts of nitrosamine products without the use of any standards.

CMS is applicable to an oxidizable analyte but direct electrochemical oxidation/reduction of nitrosamines for CMS measurement is difficult. Given this difficulty, the nitrosamines are first reduced in one embodiment. In one embodiment, a quantification process could include the step of reducing nitrosamines to hydrazines. The reduction step could be a chemical reduction step or any other reduction step such as an electrochemical reduction. CMS quantitation is then applied to quantify the hydrazines. Liquid chromatography could be employed in this embodiment.

In the liquid chromatography/electrochemical cell/mass spectrometry setup, the liquid chromatography device can be any suitable liquid chromatography instrument, such as UPLC, HPLC, or nanoLC, or other separation instrument such as electrophoresis. The mass spectrometry device can be any suitable mass spectrometer instrument with an atmospheric pressure interface. The ionization method is not limited to electrospray ionization (ESI) but also can be any suitable ionization method based on electrons, photons, ions, high energy particles, or plasmas. The electrochemical cell can be any suitable electrochemical cell employing a porous electrode, a flat electrode, or a modified electrode. It can be on chip and 3D printed.

In one embodiment, the quantitation process could be automated and performs high throughput analysis for many samples. The present system could include subsystems and components to measure and control process variables, as required for effective performance. The present system could employ sensors or other condition detection and control subsystems or components that might be required to process at a particular rate or at a particular scale. For example, a sensor could monitor and record an electrochemical current during an oxidation or reduction process in the electrochemical cell. The present system could include a controller in communication with a sensor. The controller could receive at least one process parameter, process the at least one process parameter, and adjust operation of the system based upon processing of the at least one process parameter.

Any combination and/or permutation of the embodiments is envisioned. Other objects and features will become apparent from the following detailed description considered in conjunction with the accompanying drawings. It is to be understood, however, that the drawings are designed as an illustration only and not as a definition of the limits of the present disclosure.

Accordingly, one or more embodiments of the disclosure are directed to a method for quantifying nitrosamines in a nitrosamine sample. The nitrosamine sample is analyzed using coulometric mass spectrometry (CMS) to quantify the nitrosamines. CMS quantifies the nitrosamines without internal or external standards.

Additional embodiments of the disclosure are directed to a method for quantifying nitrosamines in a nitrosamine-containing composition. The nitrosamine-containing composition is passed through a liquid chromatography instrument to generate a nitrosamine sample in an eluent from the liquid chromatography instrument. The nitrosamines in the nitrosamine sample is reduced to form hydrazines in a reduced sample. A reduction yield of the nitrosamine is determined by mass spectrometry. The nitrosamines in the nitrosamine-containing composition are quantified by measuring integrated currents from electrochemical oxidation of corresponding hydrazines. Quantifying the nitrosamines in the nitrosamine-containing composition does not use an internal or external standard.

Further embodiments of the disclosure are directed to a system for quantifying nitrosamines in a nitrosamine sample. The system comprises a liquid chromatography instrument, an electrochemical cell and a mass spectrometer. The liquid chromatography instrument is configured to separate reduced nitrosamines in the nitrosamine sample or to separate nitrosamines in the nitrosamine sample followed with online reduction with a zinc cell to convert nitrosamines into hydrazines. The electrochemical cell is configured to measure currents produced by electrochemical oxidation of hydrazines resulting from reduction of nitrosamine analytes in an eluent from the liquid chromatography instrument. The mass spectrometer is configured to measure both the reduction yields of nitrosamine analytes and the subsequent electrochemical oxidation yields of hydrazines resulting from reduction of nitrosamine analytes from the electrochemical cell.

### BRIEF DESCRIPTION OF THE DRAWINGS

To assist those of skill in the art in making and using the disclosed absolute quantification system and method and associated systems and methods, reference is made to the accompanying Figures, wherein:

FIG. 1a shows an absolute quantification system according to one or more embodiments of the disclosure;

FIG. 1b shows chemical reaction of nitrosamines to hydrazines, in accordance with one embodiment of the present disclosure;

FIG. 1c shows exemplary extracted ion chromatograms of NDMA and the reduction hydrazine product DMH signal before and after reduction using a Zn cell;

FIG. 2a shows a nESI-MS spectrum of N-nitrosodiethylamine after chemical reduction;

FIG. 2b illustrates a NMR spectrum of N-nitrosodiethylamine after chemical reduction;

FIGS. 3a and 3b show ESI-MS spectra of hydrazine 1 when the applied potential was 0 V and +0.3 V, respectively, showing that the peak of the oxidized product ion [1−H]⁺ at m/z 87 has increased intensity in FIG. 3b compared with its intensity in FIG. 3a;

FIGS. 3c and 3d show EIC of hydrazine ion at m/z 89 when the applied potential was 0 V and +0.3 V (vs Ag/AgCl), respectively;

FIGS. 3e and 3f show the electric current responses due to the oxidation of a blank solvent and hydrazine 1, respectively;

FIG. 4 illustrates a nESI-MS spectrum of 1-nitroso-4-phenylpiperazine after chemical reduction;

FIGS. 5a and 5b show ESI-MS spectra of hydrazine 2 when the applied potential was 0 V and +0.3 V (vs. Ag/AgCl), respectively, showing that the peak of the oxidized product ion [1−H]⁺ at m/z 176 has increased intensity in FIG. 5b compared with its intensity in FIG. 5a;

FIGS. 5c and 5d show EIC of hydrazine ion at m/z 178 when the applied potential was 0 V and +0.3 V (vs Ag/AgCl), respectively;

FIGS. 5e and 5f show electric current responses due to the oxidation of a blank solvent and hydrazine 2, respectively;

FIG. 6 shows the chemical structures of N-nitrosamine VII that was studied and its reduction product hydrazine 7;

FIGS. 7a and 7b show ESI-MS spectra of hydrazine 7 (from reduction of N-nitrosamine VII in the test sample with drug matrix) when the applied potential was 0 V and +0.3 V (vs. Ag/AgCl), respectively;

FIGS. 7c and 7d show EIC of hydrazine 7 at m/z 350 when the applied potential was 0 V and +0.3 V (vs Ag/AgCl), respectively;

FIGS. 7e and 7f show electric current responses due to the oxidation of a blank solvent and hydrazine 7, respectively; and

FIG. 8 illustrates a flowchart of a method for determining the nitrosamine content of a nitrosamine sample according to one or more embodiment of the disclosure.

### DETAILED DESCRIPTION

One or more embodiments of the disclosure are directed to methods for absolute quantitation of nitrosamines. CMS is applicable to oxidizable or reducible analytes but direct electrochemical oxidation/reduction of nitrosamines for CMS measurement is difficult. To solve this problem, the inventors have found that analysis can be accurately performed by reducing nitrosamines into corresponding hydrazines and then quantifying the resulting hydrazines to find out the amount of nitrosamines.

As used in this specification and the appended claims, the term “nitrosamine sample” refers to a sample containing one or more nitrosamine species and should not be limited to any particular nitrosamine species.

As used in this specification and the appended claims, a “reduced sample” refers to a sample that has at least one species that has been reduced, and should not be interpreted as relating to a volume or other physical parameter.

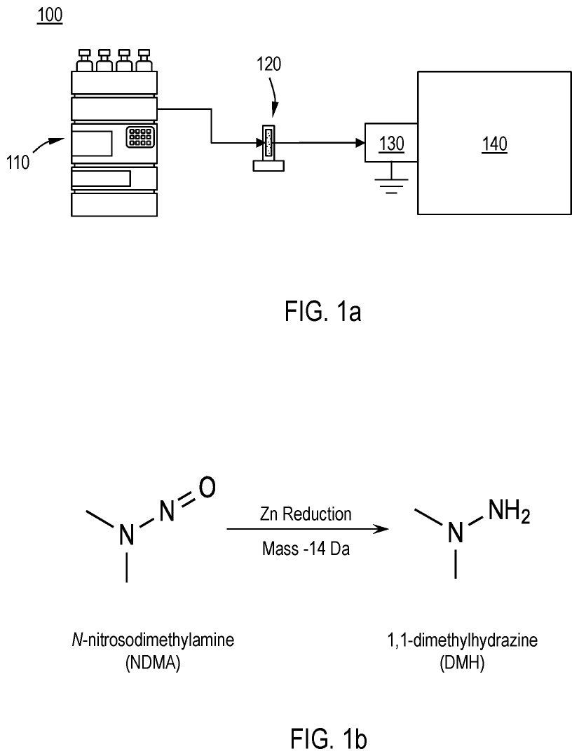

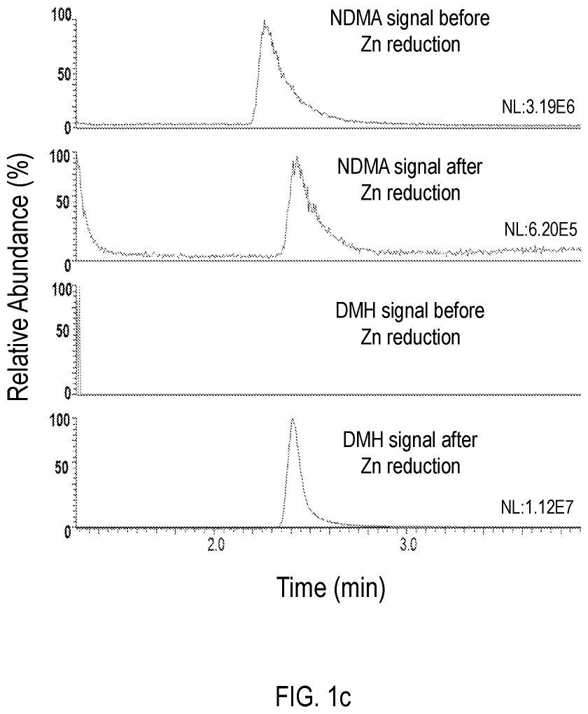

FIG. 1a illustrates a basic workflow of a CMS system 100. A suitable separation technique, e.g., high-performance liquid chromatography (HPLC) is used to separate the target analyte (a nitrosamine species or a hydrazine species from nitrosamine reduction) from a nitrosamine sample. For descriptive purposes, the separation technique is referred to as a liquid chromatography instrument 110. However, the skilled artisan will recognize that the separation technique or instrument is not limited to liquid chromatography. Suitable separation techniques include, but are not limited to, ultra-performance liquid chromatography (UPLC), high-performance liquid chromatography (LC), nano-LC, and electrophoresis.

An electrochemically active substance (e.g., hydrazines from the reduction of nitrosamines) elutes from the LC column (or from a Zinc cell) and is flowed through an electrochemical cell 120 where an electrochemical reaction (oxidation or reduction) occurs. In some embodiments, the electrochemical reaction is an oxidation of hydrazines to generate an electrochemical current signal used for quantifying hydrazines, thus providing one way to quantify the corresponding nitrosamine precursor (given the fact that the yields of reduction reaction for converting nitrosamines into hydrazines can be also measured by mass spectrometry (MS)).

FIG. 1b shows a reduction of N-nitrosodimethylamine (NDMA) using zinc as a reducing agent to form 1,1-dimethylhydrazine (DMH). Electrochemical oxidation of the resulting hydrazine results in an electrical current peak, which then can be integrated over time to obtain the total charge Q. According to Faraday's Law, the total electric charge (Q) involved in the electrochemical reaction is proportional to the quantity of the oxidized/reduced substance: Q=nzF (or n=Q/(zF)), where n denotes the moles of the oxidized/reduced analyte, z is the number of electrons transferred per molecule during the redox reaction, and F is the Faraday constant taken to be 9.65×10⁴ C/mol.

Referring back to FIG. 1a, in some embodiments, the electrochemical cell 120 is an electrochemical detector configured to analyze the eluent from the liquid chromatography instrument 110 (or from a zinc cell), and to produce electrochemical current signal for quantitation. The electrochemical cell 120 can be any suitable apparatus employing a porous electrode, a flat electrode, or a modified electrode. As used in this manner, a “modified electrode” is an electrode where its surface is deposited with other materials or catalysts. For example, direct electrochemical reduction of nitrosamine is possible using a Ru, Pt or Ni catalyst.

In some embodiments, reduction of nitrosamines can be done using zinc dust or Zinc cell. In particular, nitrosamines can be online flowed through a zinc ecell to become hydrazine. The skilled artisan will understand how to and be able to determine other suitable reducing agents through routine experimentation. FIG. 1c shows exemplary extracted ion chromatograms of NDMA and the reduction hydrazine product DMH signal before and after reduction using a Zn cell.

The electrolyzed substance from the electrochemical cell is then directed to a mass spectrometer 130 for analysis using any suitable ionization technique, e.g., an electrospray ionizer 140. In one or more embodiments, a sample of the analyte from the eluent flow through the electrochemical cell. The electrochemical cell can be turned off or on to record the mass spectra of the analyte before or after electrolysis, respectively. The redox conversion yield Δi can be determined by measuring the relative change of the target analyte peak area in the extracted ion chromatogram (EIC) upon electrolysis, from the recorded mass spectra. Thus, the total amount of the analyte can be calculated as the quotient of the amount of the oxidized/reduced analyte n and the oxidation/reduction yield Δi (i.e., Q/(zFΔi)).

The mass spectrometry device can be any suitable mass spectrometer instrument with an atmospheric pressure interface. In some embodiments, the electrospray ionizer 140 is replaced with a different ionization source. Suitable ionization sources include, but are not limited to, those employing techniques based on electrons, photons, ions, high energy particles, or plasmas. In some embodiments, the mass spectrometer is configured to measure both the reduction yields of nitrosamine analytes and the subsequent electrochemical oxidation yields of hydrazines resulting from reduction of nitrosamine analytes from the electrochemical cell.

In an exemplary CMS procedure⁹, zinc dust and N-nitrosamines are mixed in methanol/acetic acid mixture (v/v 8:1), and stirred for 2 h at room temperature under nitrogen protection. While the embodiment discusses the use of specific compounds and materials, it is understood that the present disclosure could employ other suitable compounds or materials in the reduction step (e.g., using thiourea dioxide (TDO) or electrochemical reduction). Similar quantities or measurements may be substituted without altering the method embodied above. It will be understood that nitrosamines could be reduced using any suitable reduction process, such as a chemical reduction process using either zinc dust or zinc cell, as shown in FIG. 1b, or an electrochemical reduction process.

The reduction yield using zinc dust is nearly quantitative and complete, as shown in the data below. With the hydrazines that were produced in the reduction step, selective oxidation of hydrazines can be achieved using only 0.3 V potential (vs. Ag/AgCl), which can be utilized for CMS quantitation. Unless otherwise noted, all potential values are measured against the silver/silver chloride reference electrode. The present inventors quantified the hydrazines using CMS without using any standards or calibration curves. Because the hydrazine quantity reflects the original amount of nitrosamine, nitrosamine can be quantified.

The low potential of 0.3 V for oxidation of hydrazine is quite important. For example, if it were a drug nitrosamine and included other functionalities, other functional groups would not be oxidized under such a low potential. Accordingly, the low potential guarantees that the integrated charge Q is truly from hydrazine oxidation and provides the basis of using CMS method for quantitation.

FIG. 1a is a schematic of one embodiment of an absolute quantification system. The quantification system could include an electrochemical cell (EC) connected to a mass spectrometer (MS), in which direct flow injection to the electrochemical cell or using a liquid chromatography (LC) device to inject samples into the electrochemical cell can be allowed, as illustrated in FIG. 1a. A liquid chromatography (LC) can be used to inject the reduced N-nitrosamines (i.e., hydrazines) into an electrochemical flow cell for oxidation, followed by online MS detection. Electric current is generated and recorded during electrochemical oxidation. Before and after oxidation, ion intensities of the surrogate hydrazines are also recorded using MS. Alternatively, a liquid chromatography (LC) can be used to inject N-nitrosamines into a zinc cell to be reduced into hydrazines which can be flowed into an electrochemical flow cell for oxidation, followed by online MS detection. Electric current is generated and recorded during electrochemical oxidation. Before and after oxidation, ion intensities of the surrogate hydrazines are also recorded using MS.

Although a liquid chromatography device is shown in FIG. 1a, it will be understood that other suitable processes may be employed. For example, direct flow injection may be employed for a sample analyte that is pure or that is a simple mixture composed of only a small number of constituents. In one embodiment, the electrochemical cell could include a reference electrode (RE), a counter electrode (CE), and a working electrode (WE).

As a demonstration, the present inventors used the process disclosed herein and in FIGS. 1a and 1b for absolute quantitation of different nitrosamines. FIG. 1a shows one embodiment of a setup of coupling liquid chromatography (Waters, Milford, MA), electrochemical cell (BASi, West Lafayette, IN), and a high-resolution Orbitrap QE mass spectrometry (Thermo Scientific, San Jose, CA). The thin-layer electrochemical flow cell consisted of gold as the working electrode, an Ag/AgCl electrode as the reference electrode, and a stainless steel block as the counter electrode. The target hydrazines can be separated from the reaction mixture by LC first, then undergo electrochemical oxidation in the electrochemical cell and followed with online MS detection.

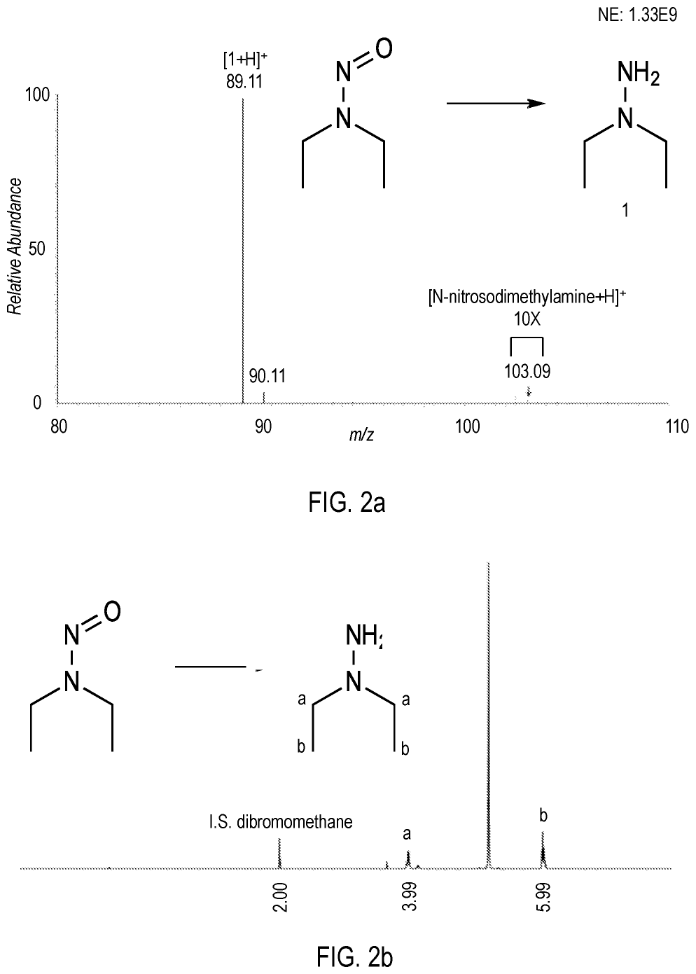

By using this setup in one embodiment, N-nitrosodiethylamine, was first chosen as a test sample. 3 μL N-nitrosodiethylamine (0.0279 mmol, 2.84 mg) and 36.6 mg zinc dust (0.56 mmol) are mixed in 450 μL methanol/acetic acid mixture (v/v 8:1), and stirred for 2 h at room temperature under nitrogen protection. Nanoelectrospray ionization mass spectrometry (nanoESI-MS) was used to evaluate the reduction yield by measuring the N-nitrosodiethylamine before and after reduction. The chemical reduction to be 99.85%, which was further confirmed with NMR yield of 99.83%, as shown in FIGS. 2a and 2b. MS reduction yield was calculated by comparing the reduction product ion intensity ([1+H]⁺: 1.33E9) to the total ion intensities of reduction product and unreduced nitrosamines ([N-nitrosodiethylamine+H]⁺: 1.99E6, negligible compared to the reduction product ion [1+H]⁺ intensity). NMR yield was measured using dibromomethane as the internal standard. MS yield was thus adopted due to the simplicity in measurement.

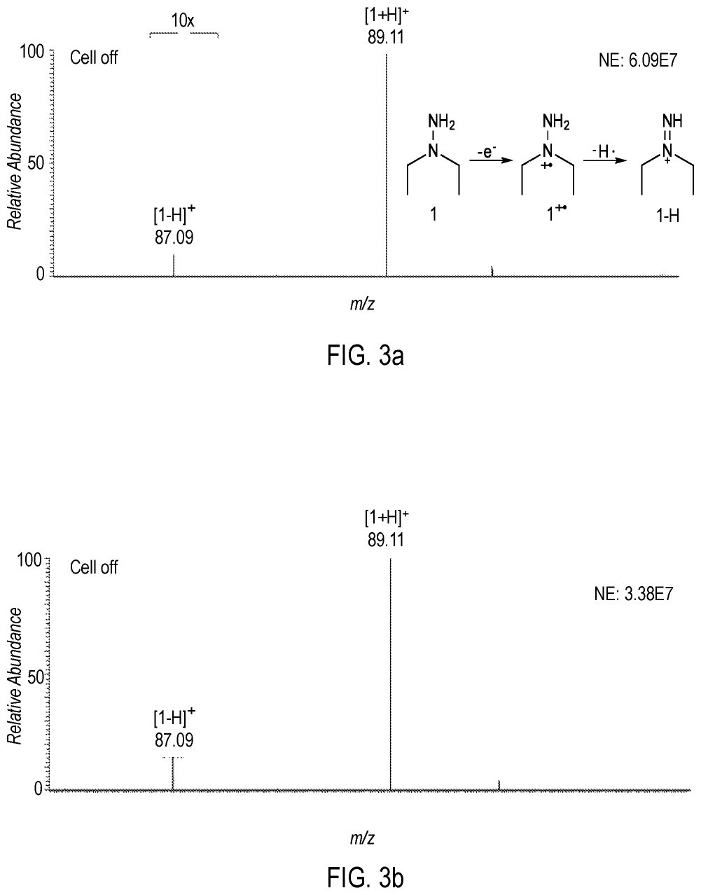

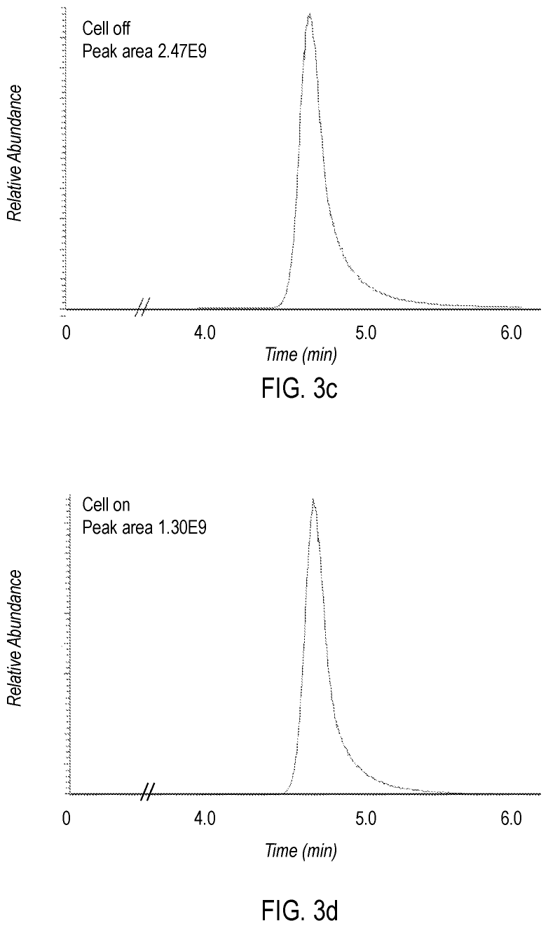

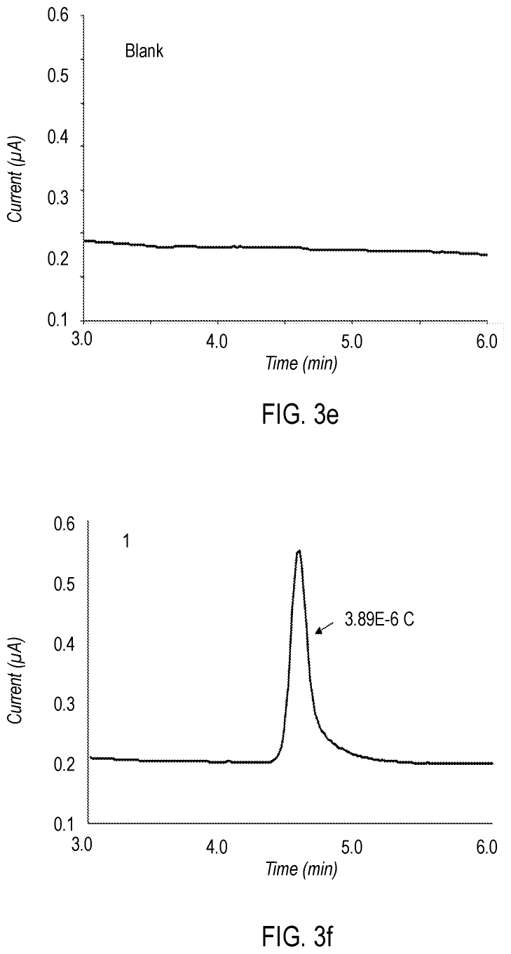

Before electrolysis, the protonated hydrazine 1 was detected at m/z 89, as shown in FIG. 3a, and a small oxidation peak at m/z 87 was observed, probably due to the in-source oxidation of 1. Referring to FIG. 3b, after electrolysis, the peak intensity at m/z 87 increased significantly. Presumably, upon electrochemical oxidation, hydrazine 1 first loses one electron to form a radical cation, which subsequently loses one hydrogen radical to get imine cation at m/z 87 during EC oxidation (thus z=1 in this case). FIGS. 3c and 3d show the EIC (m/z 89, the protonated hydrazine 1) of 27.9 μM hydrazine 1 with an injection volume of 3 μL (injected amount 83.0 pmol) with the applied potential of 0 V and +0.3 V (vs. Ag/AgCl), respectively. The integrated area for the peak shown in FIG. 3d was smaller by 47% compared to that of the peak shown in FIG. 3c, indicating that the oxidation yield for hydrazine 1 was 47%. On the other hand, the hydrazine 1 oxidation current peak was detected, as shown in FIG. 3f (FIG. 3e shows the background current diagram for the blank solvent sample under the same +0.3 V potential as a contrast). Based on the integration of the current peak area, the amount of the oxidized hydrazine 1 on average was calculated to be 38.9 pmol. Therefore, the measured amount of N-nitrosodiethylamine was 38.9 pmol/47%=82.8 pmol, which was close to the injection amount of 83.6 pmol (Theoretical amount=nitrosamine Conc. 27.9 μM ×MS reduction yield of 99.85%×LC injection volume of 3 μL=83.6 pmol), with a small quantitation discrepancy of −0.9%.

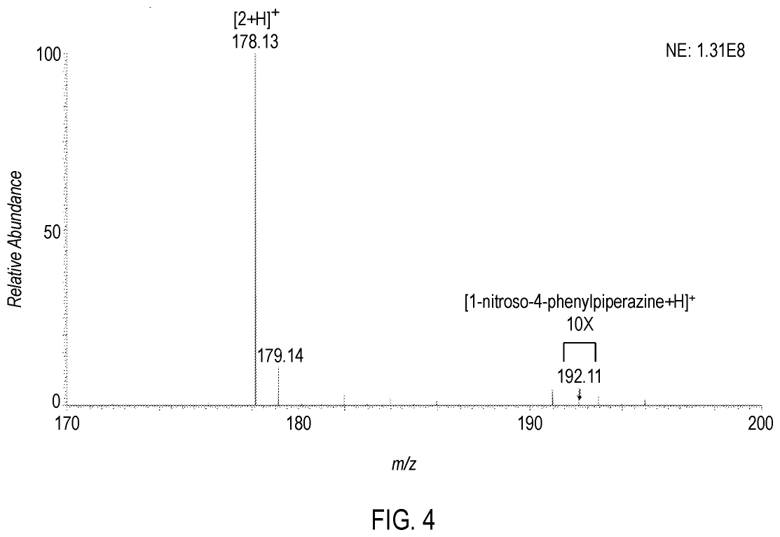

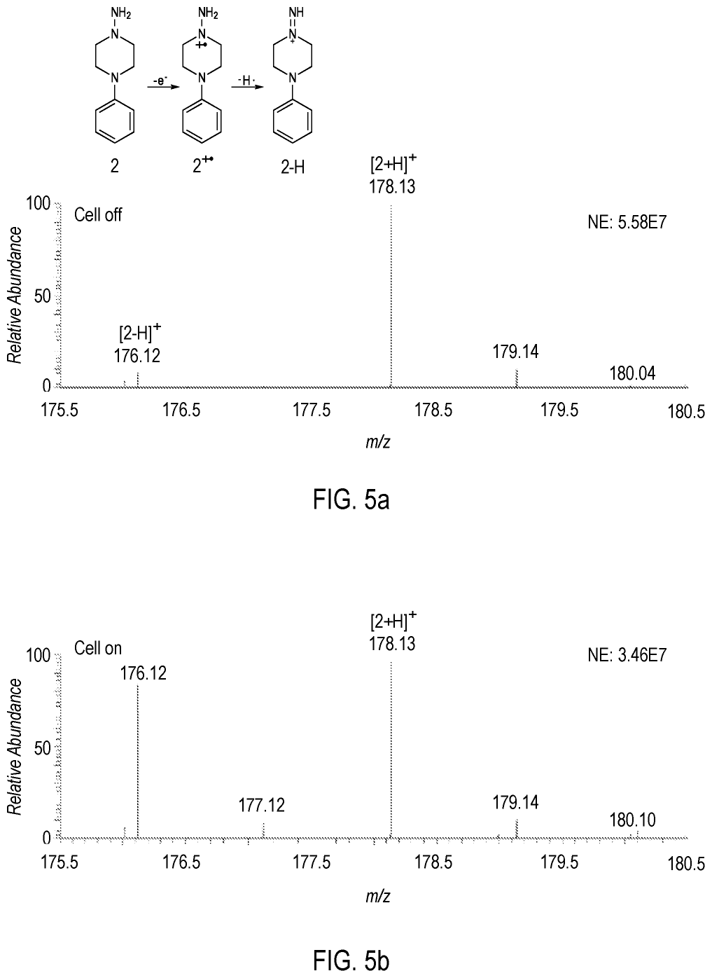

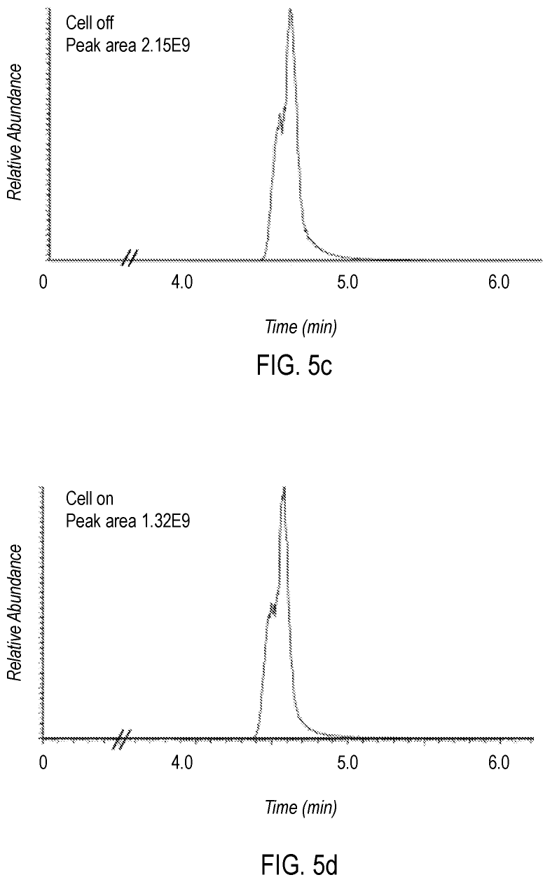

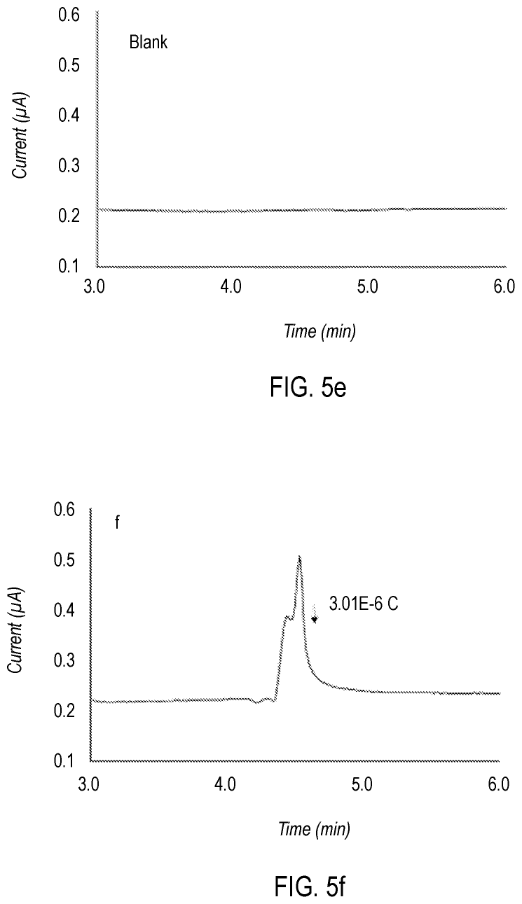

Another model N-nitrosamine, 1-nitroso-4-phenylpiperidine, was also analyzed by the same approach in one embodiment. The reduction yield of chemical reduction was calculated by nESI-MS to be 99.77%. As shown in FIG. 4, [2+H]⁺ intensity is 1.31E8 and the reduced nitrosamine ion [1-nitroso-4-phenylpiperidine+H]⁺ intensity is 3.04E5. Before electrolysis, the protonated hydrazine 2 was detected at m/z 178, as shown in FIG. 5a. A small oxidation peak at m/z 176 was observed, probably due to the in-source oxidation of 2. After electrolysis in the electrochemical cell (FIG. 5b), the peak intensity at m/z 176 increased. FIGS. 5c and 5d show the EIC (m/z 178, the protonated hydrazine 2) of 28 μM hydrazine 2 with an injection volume of 3 μL (injected amount 83.8 pmol) with the applied potential of 0 V and +0.3 V, respectively. The integrated area for the peak shown in FIG. 5d was smaller by 39% compared to that of the peak shown in FIG. 5c, indicating that the oxidation yield for hydrazine 2 was 39%. On the other hand, the hydrazine 2 oxidation current peak was detected, as shown in FIG. 5f (FIG. 5e shows the background current diagram for the blank solvent sample under the same +0.3 V potential as a contrast).

Based on the integration of the current peak area, the amount of the oxidized hydrazine 2 on average was calculated to be 32.3 pmol. Therefore, the measured amount of nitroso-4-phenylpiperidine was 32.3 pmol/39%=82.9 pmol, close to the injection amount of 83.8 pmol (Theoretical amount=nitrosamine Conc. 28.0 μM×MS reduction yield of 99.77%×LC injection volume of 3 μL=83.8 pmol) with a small measurement error of only −1.1%.

In addition, the present inventors tested the method sensitivity. With the prototype setup, the present inventors were able to quantify nitrosamine as low as 0.87 pmol (˜0.16 nanogram). Also, CMS can provide mass information for nitrosamine, as exemplified in FIGS. 3 and 5 and thus can identify nitrosamines as well.

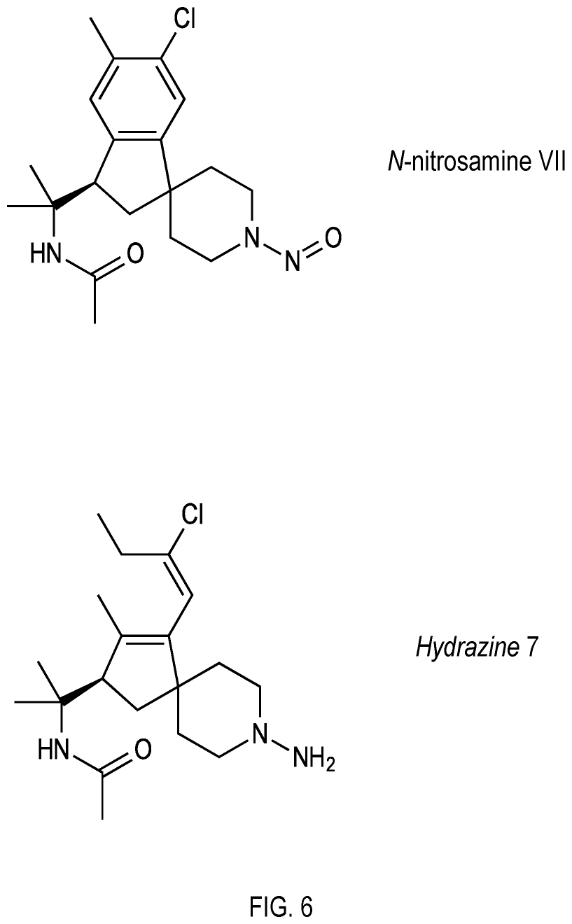

Finally, CMS was applied for quantitative analysis of N-nitrosamine VII ((R)-N-(2-(6-chloro-5-methyl-1′-nitroso-2,3-dihydrospiro[indene-1,4′-piperidin]-3-yl) propan-2-yl) acetamide, Structure shown in FIG. 6), a drug-like N-nitrosamine, in presence of drug matrix containing various excipients. In one experiment, to mimic N-nitrosamine in drug product, 150 ng of N-nitrosamine VII was doped with 10 g drug matrix (15 ppb) containing corn starch, D&C red #27 aluminum lake, dicalcium phosphate, magnesium stearate microcrystalline cellulose, polyethylene glycol, polyvinyl alcohol, silicon dioxide, stearic acid, talc, and titanium dioxide. In the experiment, N-nitrosamine VII was first extracted from the drug matrix via solvent extraction (using 2-propanol) and isolated by LC using the reverse-phase chromatography, followed by zinc reduction to afford hydrazine 7 (Structure shown in FIG. 6). The extraction yield, reduction yield, and amine side product percentage were determined using LC/MS analysis based on EIC peak areas. Finally, as mentioned before, CMS was employed for the hydrazine product quantitation.

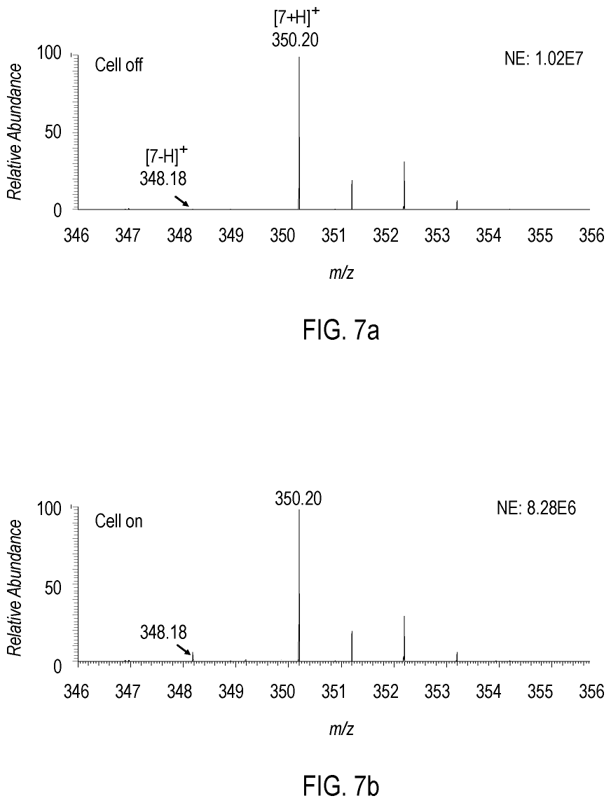

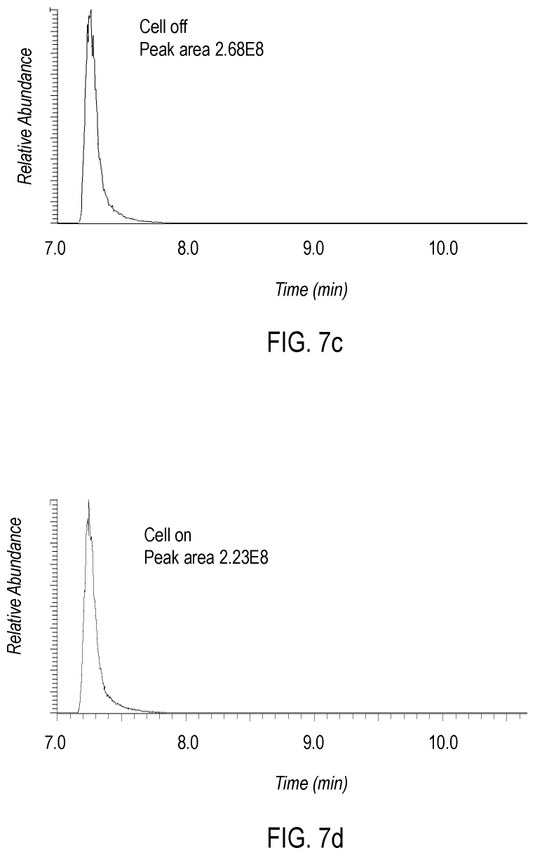

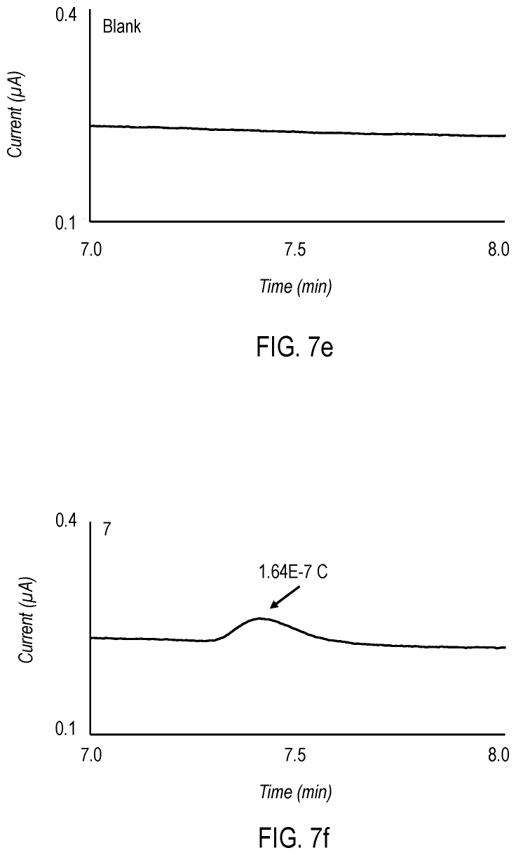

As shown in FIGS. 7a and 7b, the oxidation product ion at m/z 348 had increased intensity when +0.3 V potential (vs. Ag/AgCl) was applied to WE. The protonated hydrazine 7 ion of m/z 350 shown in FIG. 7d was smaller by 16.9% than that of the peak shown in FIG. 7c, suggesting the oxidation yield to be 16.9%. On the other hand, the 7 oxidation current peak was detected, as shown in FIG. 7f (FIG. 7e shows the background current diagram for the blank solvent sample under the same +0.3 V potential as a contrast). Based on the integration of the current peak area, the amount of the oxidized 7 was calculated to be 10.0 pmol (ca. 3.5 ng). Considering the extraction and isolation yield (43.9%), the side product ratio (4.4%), the reduction yield (58.1%), and the dilution factor 10, the CMS measured amount of VII was 10 pmol/43.9%/(1-4.4%)/58.1%*10=410 pmol on the average from a triplicate measurement. The measurement error was −1.1% compared with the theoretical amount of 412 pmol (i.e., 150 ng N-nitrosamine VII).

These results show the feasibility of using an oxidation electric current to quantify N-nitrosamine concentrations. The experimental protocol is simple and could be used to measure many samples quickly. The major strength is that standards or calibration curves for quantitation are not required. Therefore, it is fast and cost-effective. Furthermore, LC is used in one embodiment of the method. Analytes in a complex sample can be separated and then quantified. This method could significantly impact pharmaceutical quality control, food safety analysis, and water treatment applications in the future.

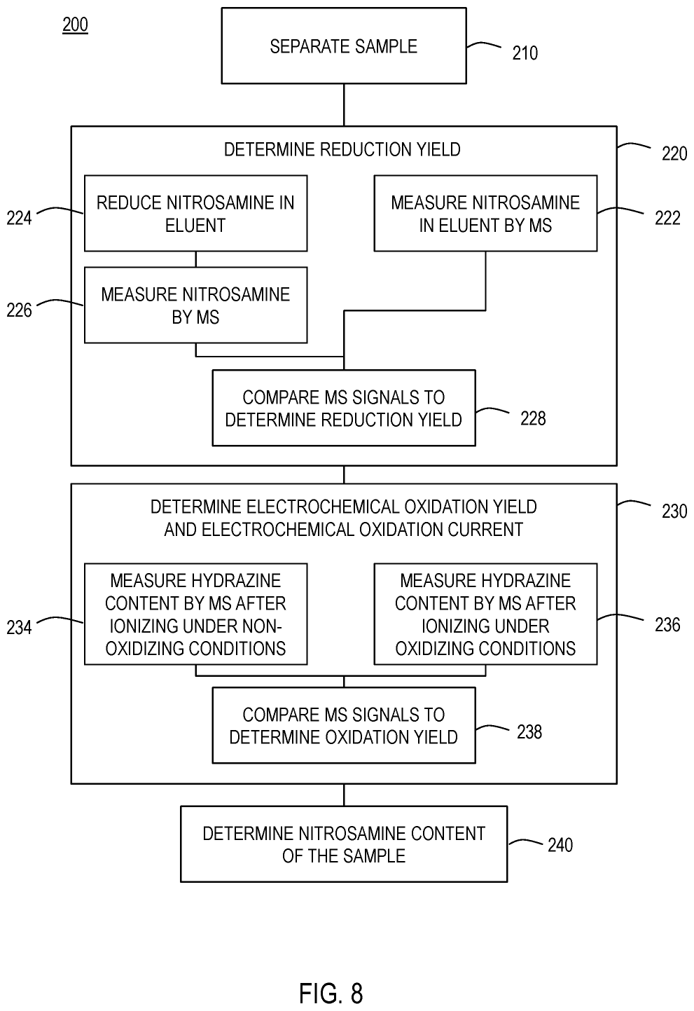

FIG. 8 illustrates a method 200 of determining nitrosamines in a nitrosamine sample. In some embodiments, the nitrosamine sample includes active pharmaceutical ingredients (API)-related nitrosamines or new nitrosamines whose standards are commercially lacking. The illustrated method 200 includes optional steps which may not be needed or used for any particular analysis, as described herein, and may be performed on an CMS system 100 as illustrated in FIG. 1a. In some embodiments, method 200 results in the analysis of the nitrosamine sample using coulometric mass spectrometry (CMS) to quantify the nitrosamines, wherein CMS quantifies the nitrosamines without internal or external standards. Briefly, the method of some embodiments comprises measuring amounts of hydrazine products resulting from nitrosamine reduction, and quantifying the nitrosamines in the sample using the amounts of hydrazine products.

At operation 210, a nitrosamine sample (e.g., a pharmaceutical formulation) is separated by any suitable separation technique known to the skilled artisan. In some embodiments, operation 210 is performed using a liquid chromatography (e.g., an HPLC, UPLC, nano-LC instrument). Separation of the nitrosamine sample allows for the quantitation of the nitrosamine species without interference from non-intended compounds. The skilled artisan will recognize that operation 210 is optional based on whether or not separation of the nitrosamine species is needed or desired.

The reduction yield of the nitrosamine sample is determined at optional operation 220. Operation 220 of the CMS process determines the reduction yield of the sample by reducing the nitrosamine in the sample to hydrazine to form a reduced sample. At operation 222, the nitrosamine content of the nitrosamine sample is determined by mass spectrometry.

At operation 224, the nitrosamine sample is reduced (e.g., by passing through a zinc disc/column) to generate a reduced sample. The reduced sample is then analyzed in mass spectrometer 130 at operation 226 to determine the nitrosamine content of the reduced sample.

At operation 228, the nitrosamine signals from operations 222 and 226 are evaluated to determine the reduction yield. The reduction yield is determined by comparing the nitrosamine MS signal from the reduced sample (operation 226) to the nitrosamine MS signal from the nitrosamine sample (operation 222). The amount of nitrosamine remaining in the sample after reduction can vary depending on, for example, the reduction conditions and the particular nitrosamine species. In some embodiments, the reduction yield is sufficiently high (e.g., >95%) so that future determination of the reduction yield for that nitrosamine species, under the sample reduction conditions, can be omitted, making operation 220 optional.

In some embodiments, at operation 224, reducing the nitrosamines in the sample is a chemical reduction step. In some embodiments, the nitrosamines in the sample are reduced by passing the sample through a zinc cell. In some embodiments, the zinc cell comprises one or more of a zinc column or a zinc disc. In some embodiments, the nitrosamines in the sample are reduced by mixing zinc dust with the sample in a methanol/acetic acid mixture.

The electrochemical oxidation yield of the hydrazine sample in the electrochemical cell 120 and the hydrazine electrochemical oxidation current are determined at operation 230. Operation 230 of the CMS process determines the oxidation yield of the hydrazine sample by comparing the MS signal of an oxidized sample and a non-oxidized sample of the hydrazine species. The hydrazine electrochemical oxidation current is recorded using a potentiostat. In some embodiments, quantifying the hydrazine content in the reduced sample is performed without a hydrazine standard. Stated differently, measuring the amounts of hydrazine products comprises obtaining electrochemical oxidation currents from the hydrazine products in an electrochemical cell and determining the electrochemical oxidation yield for the hydrazine products in the reduced sample by mass spectrometry measurement of the reduced nitrosamine sample before and after electrochemical oxidation.

At operation 234, the reduced sample is ionized under conditions before electrochemical oxidation of the hydrazine species. For example, the electrochemical cell 120 of some embodiments is operated without a bias oxidation voltage. A mass spectrum of the reduced sample by mass spectrometry using a non-oxidizing ionization source is obtained.

At operation 236, the reduced sample is ionized under conditions after electrochemical oxidation of the hydrazine species. For example, the electrochemical cell 120 of some embodiments is operated at a bias voltage (e.g., +0.3V vs. Ag/AgCl). A mass spectrum of the reduced sample by mass spectrometry using an oxidizing ionization source is obtained.

At operation 238, the electrochemical oxidation yield for the hydrazine in the reduced sample is determined from the mass spectrum from the non-oxidizing and oxidizing ionization sources.

At operation 240, the nitrosamine content in the nitrosamine sample is quantified using both the recorded hydrazine electrochemical oxidation current and the electrochemical oxidation yield of hydrazine.

In some embodiments, the method 200 further comprises confirming that the hydrazine in the reduced sample is from the nitrosamine in the nitrosamine sample by analyzing the m/z ratio of a base peak in the mass spectrum of the reduced sample and the base peak in the mass spectrum of the nitrosamine sample.

In another aspect of the disclosure, the inventors have found that a Zinc cell which contains a Zinc disc can enable online reduction of nitrosamine. As shown in FIG. 1a, the Zinc cell can be placed in between liquid chromatograph (LC) and a mass spectrometer (MS). A nitrosamine sample (such as N-nitrosodimethylamine (NDMA)) can be delivered to the Zn cell and undergo reduction to form a hydrazine product (e.g., 1,1-dimethylhydrazine (DMH)) with no observable side products of dimethylamine. With reference to FIG. 1c, based on the NDMA signal before and after Zn online reduction, it was observed that 81% NDMA was reduced using the Zn cell. Furthermore, the DMH product was observed after reduction. The ion signal of DMH was observed to be about 4 times greater than that of NDMA.

In some embodiments, online nitrosamine reduction (e.g., by Zn) decreases the time and complexity for the nitrosamine quantitation by CMS. For example, in some embodiments, an offline Zn dust powder reduction of nitrosamine into hydrazine was performed. This offline reduction was time consuming.

In some embodiments, the CMS process with online reduction improves the nitrosamine detection sensitivity and selectivity. As it can be seen from FIG. 1c, the reduction product DMH signal is much higher (1.12×10⁷) than the original NDMA signal (3.19×10⁶). This improvement in detection sensitivity allows for the trace analysis of nitrosamine impurities in drugs.

The online reduction gives rise to a hydrazine product. The characteristic mass shift between the precursor ion and the product ion by −14 Da (corresponding to the conversion of —NNO into —NH₂, as shown in FIG. 1b). Some embodiments of the disclosure provide an efficient way to quickly identify what species is nitrosamine following LC separation of an unknown drug sample. Some embodiments advantageously provide an efficient way to identify which species in the drug (or other sample) is the unknown nitrosamine.

In some embodiments, a Zn column or disc with large surface areas can be used to convert nitrosamine back to its original amine state (i.e., the original drug state) via a reduction reaction. This process may provide a way to remove the nitrosamine impurity in the drug. The online reduction process may be scalable to production levels as a way of removing drug impurity nitrosamines from drug products.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

### REFERENCES

ADDIN EN.REFLIST 1. Venkatesan, A. K.; Pycke, B. F. G.; Halden, R. U., Detection and Occurrence of N-Nitrosamines in Archived Biosolids from the Targeted National Sewage Sludge Survey of the U.S. Environmental Protection Agency. Environmental Science & Technology 2014, 48, 5085-5092.
2. Research, F. a. D. A. C. f. D. E. a., Guidance for Industry: Control of Nitrosamine Impurities in Human Drugs. FDA Maryland: 2021.
3. Giménez-Campillo, C.; Pastor-Belda, M.; Campillo, N.; Hernández-Córdoba, M.; Viñas, P., Development of a new methodology for the determination of N-nitrosamines impurities in ranitidine pharmaceuticals using microextraction and gas chromatography-mass spectrometry. Talanta 2021, 223, 121659.
4. Administration, U. S. F. D., Liquid Chromatography-High Resolution Mass Spectrometry (LC-HRMS) Method for the Determination of NDMA in Ranitidine Drug Substance and Drug Product. 2019.
5. Administration, U. S. F. D., Liquid Chromatography-Tandem Mass Spectrometry (LC-MS/MS) Method for the Determination of NDMA in Ranitidine Drug Substance and Solid Dosage Drug Product. 2019.
6. Cetó, X.; Saint, C. P.; Chow, C. W. K.; Voelcker, N. H.; Prieto-Simón, B., Electrochemical detection of N-nitrosodimethylamine using a molecular imprinted polymer. Sensors and Actuators B: Chemical 2016, 237, 613-620.
7. Majumdar, S.; Thakur, D.; Chowdhury, D., DNA Carbon-Nanodots based Electrochemical Biosensor for Detection of Mutagenic Nitrosamines. ACS Applied Bio Materials 2020, 3, 1796-1803.
8. Breider, F.; von Gunten, U., Quantification of Total N-Nitrosamine Concentrations in Aqueous Samples via UV-Photolysis and Chemiluminescence Detection of Nitric Oxide. Anal Chem 2017, 89, 1574-1582.
9. Mohamed, O. G.; Khalil, Z. G.; Capon, R. J., Prolinimines: N-Amino-I-Pro-methyl Ester (Hydrazine) Schiff Bases from a Fish Gastrointestinal Tract-Derived Fungus, Trichoderma sp. CMB-F563. Organic Letters 2018, 20, 377-380.

What is claimed is:

1. A method for quantifying nitrosamines in a nitrosamine sample, the method comprising:
analyzing the nitrosamine sample using coulometric mass spectrometry (CMS) to quantify the nitrosamines, wherein CMS quantifies the nitrosamines without internal or external standards.

2. The method of claim 1, wherein CMS comprises:
quantifying the nitrosamines in the sample by measuring amounts of hydrazine products resulting from nitrosamine reduction.

3. The method of claim 2, wherein measuring the amounts of hydrazine products comprises:
obtaining electrochemical oxidation currents from hydrazines in an electrochemical cell;
; and
determining the electrochemical oxidation yield for the hydrazine products in the reduced sample by mass spectrometry measurement of the reduced nitrosamine sample before and after electrochemical oxidation.

4. The method of claim 3, wherein quantifying the hydrazine contents in the reduced sample is performed without hydrazine standards.

5. The method of claim 2, further comprising determining reduction yields of the sample by reducing the nitrosamines in the sample to hydrazines to form the reduced sample.

6. The method of claim 5, wherein determining the reduction yields comprises comparing a nitrosamine signal from the reduced sample to a nitrosamine signal from the nitrosamine sample.

7. The method of claim 6, wherein reducing the nitrosamines in the sample is a chemical reduction step.

8. The method of claim 6, wherein the nitrosamines in the sample are reduced by passing the sample through a zinc cell.

9. The method of claim 8, wherein the zinc cell comprises one or more of a zinc column or a zinc disc.

10. The method of claim 6, wherein the nitrosamines in the sample are reduced by mixing zinc dust with the sample in a methanol/acetic acid mixture.

11. The method of claim 2, further comprising confirming that the hydrazine in the reduced sample is from the nitrosamine in the sample by analyzing an m/z ratio of a base peak in a mass spectrum of the reduced sample and a base peak in a mass spectrum of the nitrosamine sample.

12. The method of claim 2, further comprising separating the nitrosamines from the nitrosamine sample using liquid chromatography.

13. A method for quantifying nitrosamines in a nitrosamine-containing composition, the method comprising:
passing the nitrosamine-containing composition through a liquid chromatography instrument to generate a nitrosamine sample in an eluent from the liquid chromatography instrument;
reducing the nitrosamines in the nitrosamine sample to form hydrazines in a reduced sample;
determining a reduction yield of the nitrosamine by mass spectrometry; and
quantifying the nitrosamines in the nitrosamine-containing composition by measuring integrated currents from electrochemical oxidation of corresponding hydrazines,
wherein quantifying the nitrosamines in the nitrosamine-containing composition does not use an internal or external standard.

14. The method of claim 13, wherein determining the reduction yield comprises:
obtaining a mass spectrum of the nitrosamine sample in the eluent without reducing the nitrosamines to form hydrazine;
obtaining a mass spectrum of the nitrosamine sample after reduction; and
determining the reduction yield for the nitrosamine in the reduced sample by determining a ratio of a signal from the mass spectrum of the nitrosamine sample without reduction relative to a signal from the mass spectrum of the nitrosamine sample after reduction.

15. The method of claim 13, further comprising confirming that the hydrazine in the reduced sample is from the nitrosamine in the sample by analyzing an m/z ratio of a base peak in a mass spectrum of the reduced sample and a base peak in a mass spectrum of the nitrosamine sample.

16. A system for quantifying nitrosamines in a nitrosamine sample, the system comprising:
a liquid chromatography instrument configured to separate reduced nitrosamines in the nitrosamine sample or to separate nitrosamines in the nitrosamine sample followed with online reduction with a zinc cell to convert nitrosamines into hydrazines;
an electrochemical cell configured to measure currents produced by electrochemical oxidation of hydrazines resulting from reduction of nitrosamine analytes in an eluent from the liquid chromatography instrument; and
a mass spectrometer configured to measure both the reduction yields of nitrosamine analytes and the subsequent electrochemical oxidation yields of hydrazines resulting from reduction of nitrosamine analytes from the electrochemical cell.

17. The system of claim 16, wherein the liquid chromatography instrument comprises one or more of an ultra-performance liquid chromatography instrument, a high-performance liquid chromatography instrument, a nano-LC device or an electrophoresis device.

18. The system of claim 16, wherein the mass spectrometer comprises an electrospray ionization source (ESI) or a nanoelectrospray ionization source (nanoESI)

19. The system of claim 16, wherein the electrochemical cell comprises one or more of a porous electrode, a flat electrode, or a modified electrode.

20. The system of claim 16, wherein the electrochemical cell is configured to measure currents produced by direct electrochemical oxidation/reduction of nitrosamine analytes in an eluent from the liquid chromatography instrument using a modified electrode carrying electrocatalyst.
